(19) United States
(12) Patent Application Publication
(10) Pub. No.: US 2006/0256430 A1
(43) Pub. Date: Nov. 16, 2006

(54) Microscope and focusing device for a microscope

(75) Inventor: Minhua Zhu, Shanghai (CN)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Ltd., Shanghai (CN)

(21) Appl. No.: 11/431,724

(22) Filed: May 10, 2006

(30) Foreign Application Priority Data
May 11, 2005 (CN) CN 200510071298.6

(51) Int. Cl. G02B 21/00

(52) U.S. Cl. 359/383; 359/368

(57) ABSTRACT

A microscope includes a microscope stand, a focusing device, an operating element, a pin and an adjustable stop. The focusing device is disposed inside the microscope stand and includes a first axle and a second axle. A first gear wheel is disposed on the first axle and a second gear wheel is disposed on the second axle. The second gear wheel includes a slot. The first and second gear wheels cooperate so as to transfer rotating movement from the first axle to the second axle. The operating element is movably disposed at an end of the focusing device that projects through a side wall of the microscope stand. The pin slides in the slot of the second gear wheel. The adjustable stop is disposed on the focusing device so as to be contactable by the pin.

Priority is claimed to Chinese patent application CN 200510071298.6, filed May 11, 2005, the entire subject matter of which is hereby incorporated by reference herein.

The invention relates to a microscope. In particular the invention relates to a microscope which has a height adjustable focusing device. The invention furthermore relates to a focusing device for a microscope.

### BACKGROUND

Microscopes are well known instruments. The focusing with upright microscopes is done by a change of the relative position of the sample on the microscope stage and the objective in the working position. This can be done by moving the turret or by moving the microscope stage on which the sample to be investigated is positioned. According to one embodiment the sample is positioned in a special slide or sample holder and the microscope stage is moved in the direction of the optical axis of the objective which is in the operating position. A focusing by moving the microscope stage is mainly done in upright microscopes.

The focusing is initiated by the user when using at least one of the operating elements provided at the microscope stand, which causes the microscope stage to move in the direction of the optical axis of the objective. In general the operating elements comprise an operating element for the fine focus and an operating element for the coarse focus. The operating elements are in the form of a rotating knob. Both rotating knobs are arranged on a common rotating axis. The rotational movement of either rotating knob is transferred into a linear movement of the microscope stage.

The operating element or the operating elements are provided at a fixed position at a side wall of the microscope stand. The operating elements are arranged at a certain distance from the support on which the microscope is placed. The arrangement of the operating elements is optimized for the average user. For users with large hands the arrangement of the operating elements is too low and for users with small hands the arrangement of the operating elements is too high. Consequently, the use of the microscope by a non-average user is not ergonomic, and is also fatiguing or may cause muscle tension.

The German patent application DE 103 40 721.9 shows a focusing device which allows a height adjustment of the focusing device. As a consequence of the height adjustment the position of the operating elements at the side wall of the microscope is changed. The position of the operating elements is adjustable to the user's ergonomic requirements and/or preferences. It has not been previously appreciated that by changing the position of the operating elements the level of the microscope stage changes as well. The range of travel of the microscope stage is shifted and this may cause damage of the slide or the microscope objective.

The U.S. patent application Ser. No. 10/810,336 discloses a focusing device arranged inside the microscope stand and at least one operating element is provided at a first and a second end of the focusing device each of which protrudes through a side wall of the microscope stand. The focusing device has an adjustable stop mechanism to limit the relative movement of the microscope stage in the direction of the optical axis. The adjustable stop mechanism comprises a plurality of parts and does not allow an easy and cost effective assembly.

### SUMMARY OF THE INVENTION

It is an object of the present invention to provide a microscope which is ergonomic to use for various users, avoids any potential damage to the microscope objective and/or the microscope slide and is of a simple and cost effective construction.

The present invention provides a microscope comprising:

a microscope stand;

a focusing device disposed inside the microscope stand, the focusing device including a first axle and a second axle, a first gear wheel disposed on the first axle and a second gear wheel disposed on the second axle, the second gear wheel including a slot, the first and second gear wheels configured to cooperate so as to transfer rotating movement from the first axle to the second axle;

at least one operating element movably disposed at an end of the focusing device, the end of the focusing device projecting through a side wall of the microscope stand;

a pin slidably received in the slot of the second gear wheel; and

an adjustable stop disposed on the focusing device so as to be contactable by the pin.

It is a further, alternative object of the present invention to provide a focusing device for a microscope which is ergonomic to use for various users, avoids any potential damage to the microscope objective and/or the microscope slide and is of a simple and cost effective construction.

The present invention also provides a focusing device for a microscope, the focusing device comprising:

a first axle having a first gear disposed thereon;

a second axle having a second gear wheel disposed thereon, the second gear wheel including a slot, the second gear wheel configured to cooperate with the first gear wheel so as to transfer rotating movement from the first axle to the second axle;

at least one movably disposed operating element attached to the first axle and configured to effect movement of a microscope stage along an optical axis of the microscope;

a pin slidably received in the slot of the second gear wheel; and

an adjustable stop disposed on the focusing device so as to be contactable by the pin.

The microscope has at least one operating element which is provided at a first and a second end of the focusing device, each of which protrudes through a side wall of the microscope stand. A microscope stage is mounted moveably to the microscope stand. At least one objective is provided which defines in its working position an optical axis. Said at least one operating element of the focusing device effects a relative movement between the microscope stage and the objective. An elongated slot is provided at each side wall of the microscope stand which allows a change of the position of said at least one operating element in a horizontal and vertical direction. The focusing device is provided with a pivot axis around which the focusing device and consequently said at least one operating element is pivotable so that the position of the operating element is adjustable with respect to a side wall of the microscope stand.

The slot formed in the gear wheel on the second axle has the form of an arc, defining a first end and a second end, wherein both of which limit the sliding movement of the pin. The adjustable stop is an adjustable screw mounted in a recess of the focusing device and extending trough the focusing device, such that the pin can be in operational relationship with a top end and the bottom end of the adjustable screw. The pin slides in said slot while the adjustable screw is in contact with the pin and the pin not being in contact with the first end and the second end of the slot. The second axle carries a gear wheel arrangement which comprises a first gear wheel and a second gear wheel arranged coaxially. The first gear wheel has the slot and a larger diameter than the second gear wheel, wherein the rotational movement of the first axle is transferred by the first gear wheel to the gear wheel arrangement on the second axle. A gear wheel is formed on the first axle of the focusing device and a gear wheel arrangement is provided on a second axle. The pin is mounted at the periphery of the first gear wheel.

### BRIEF DESCRIPTION OF THE DRAWINGS

There are various ways of advantageously embodying and developing the teaching of the present invention. Reference is made to the drawings. In the drawings:

FIG. 1 shows a side view of a microscope in which the invention is embodied;

FIG. 2 shows a perspective view of the microscope, wherein several elements are not shown in order to better show the elements of the microscope which utilize the invention;

FIG. 3 shows an embodiment of a 3-dimensional view of the focusing device according to the present invention;

FIG. 4 shows the arrangement of the focusing device inside the microscope stand, wherein the pin is in contact with the upper end of the adjustable stop;

FIG. 5 shows the arrangement of the focusing device inside the microscope stand, wherein the pin is in contact with the bottom end of the adjustable stop;

FIG. 6 shows a side view of the gear wheel arrangement; and

FIG. 7 shows a plan view of the gear wheel arrangement.

### DETAILED DESCRIPTION

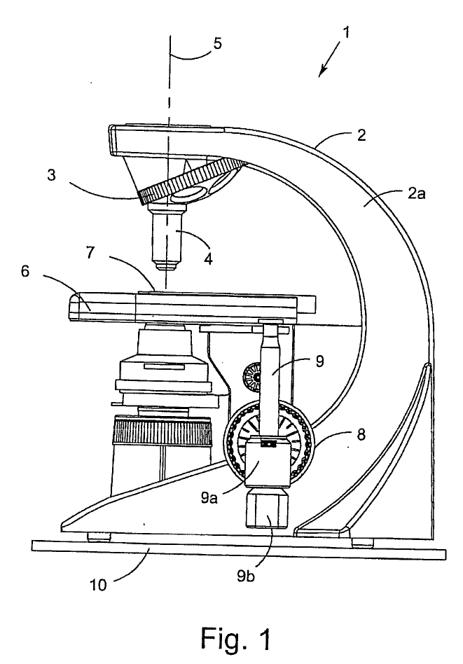

In the FIGS. 1 to 7 similar elements are marked with the same reference numeral.

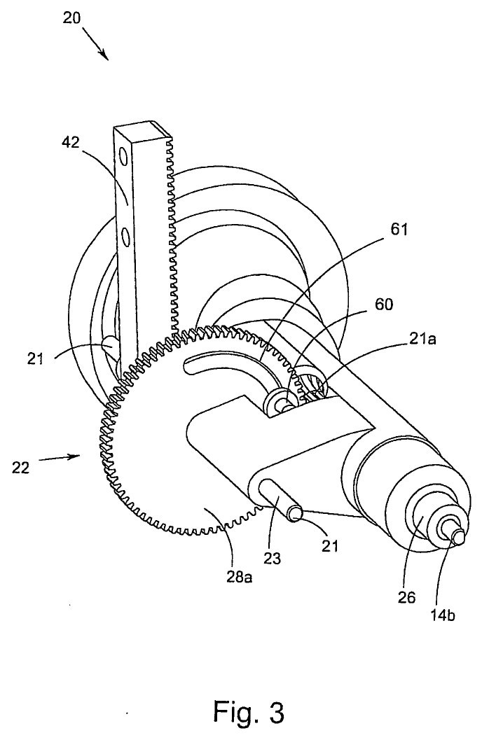

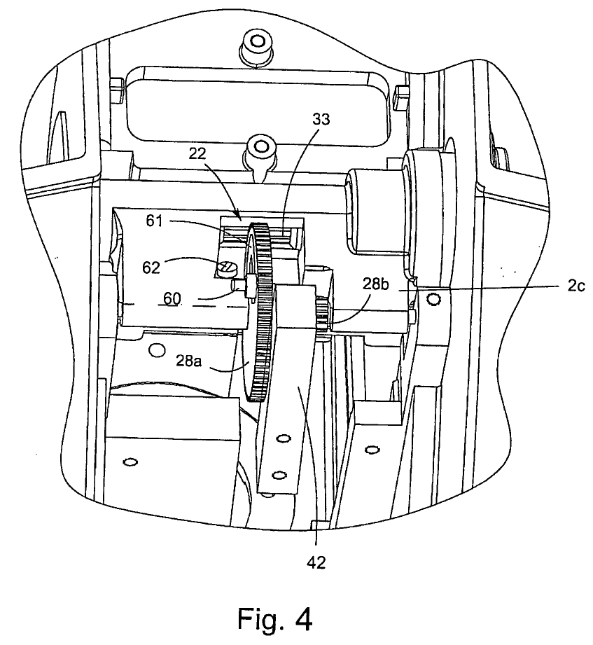

FIG. 1 shows a side view of microscope 1, which embodies the teaching of the present invention. Microscope 1 has a microscope stand 2. Microscope 1 is placed on support 10. Additionally, turret 3 is provided at microscope stand 2, wherein the turret carries at least one objective 4. Objective 4 is moved by turret 3 into a working position. Objective 4 defines optical axis 5, which is perpendicular to microscope stage 6, when objective 4 is in the working position. On microscope stage 6 sample 7 to be investigated can be placed. Microscope 1 includes focusing device 20 (see FIG. 3), which is used to bring sample 7 into focus. Focusing device 20 is mounted inside of microscope stand 2 (see FIG. 4). With this focusing device 20 microscope stage 6 can be moved relative to microscope stand 2 in the direction of optical axis 5 of objective 4. Focusing device 20 carries two operating elements 8. Each operating element 8 is attached at one of two side walls 2a and 2b of microscope stand 2. With these operating elements 8 the user can effect a positioning of microscope stage 6 in the direction of the optical axis. The positioning of microscope stage 6 results in focusing of sample 7 placed on microscope stage 6. In front of operating element 8 positioning element 9 is provided. Positioning element 9 is connected to microscope stage 6 and enables a positioning of microscope stage 6 perpendicularly to optical axis 5, which in turn enables a positioning of object 7 in the imaging field of objective 4. Positioning element 9 has X-element 9a, which enables positioning of microscope stage 6 in the X-direction. Additionally, positioning element 9 has a Y-element 9b, which enables positioning of microscope stage 6 in the Y-direction.

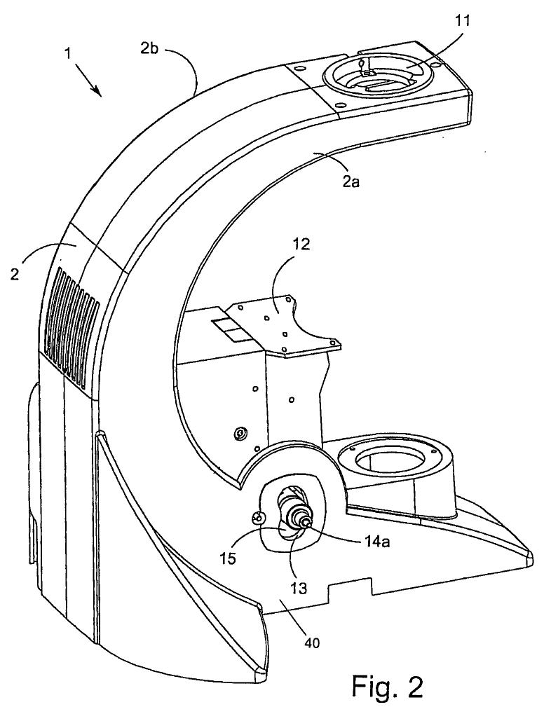

FIG. 2 provides a perspective view of microscope 1, wherein several elements are not shown in order to obtain a better view of microscope stand 2. Microscope stand 2 has a flange 11 for mounting a tube. In addition, microscope stand 2 includes mounting element 12 for microscope stage 6 (see FIG. 1). Mounting element 12 is moved by focusing device 20 parallel to optical axis 5 of objective 4 which is placed in the operating position. Inside microscope stand 2 focusing device 20 is mounted, wherein focusing device 20 has first end 14a and second end 14b (see FIG. 3). First and second ends 14a and 14b extend through opening 15, which is formed in first and second side walls 2a and 2b of microscope stand 2. As already mentioned in the description of FIG. 1 operating element 8 is mounted at first end 14a and at second end 14b. In the embodiment as shown in FIG. 2 opening 15 has the shape of a curved oblong hole, which is formed in opposing side walls 2a and 2b of the microscope stand 2. It should be obvious to a person having ordinary skill in the art that opening 15 may as well be in the shape of a straight hole.

At least one operating element 8 is mounted to focusing device 20 and is operably positioned at side wall 2a or 2b of microscope stand 2. A rotation of operating element 8 causes an upward or a downward movement of microscope stage 6. Focusing device 20 which is positioned inside microscope stand 2 can be pivoted, which causes a movement of operating element 8 at side wall 2a of microscope stand 2 away or towards base 40 on microscope stand 2. According to the height adjustment of operating element 8 microscope stage 6 moves as well. Consequently, it becomes necessary that the travel of microscope stage 6 caused by the use of operating elements 8 is limited in order to avoid damage to a sample placed on microscope stage 6 or the objectives.

FIG. 3 shows a 3-dimensional view of focusing device 20 which is mounted inside of microscope stand 2. Focusing device 20 defines pivot axis 23, around which focusing device 20 can be pivoted. Focusing device 20 comprises two elongated bore holes 25 through which a pin of an axis (not shown in FIG. 3) is guided, with which focusing device 20 is mounted pivotable inside microscope stand 2. A pivot axis 23 of focusing device 20 is coaxial with a second axle 21. A first axle 26 is provided within the focusing device 20 and is parallel to the second axle 21. The first axle 26 defines first and second ends 14a and 14b, to each of which operating element 8 of focusing device 20 is mounted. The rotating movement between first axle 26, focusing device 20 and second axle 21 is transmitted without any slip. Accordingly, gear wheel arrangement 22 is fixed on second axle 21. A plurality of gear teeth are formed at an area in the middle of first axle 26 and constitute first gear wheel 21a. Gear wheel arrangement 22 comprises first gear wheel 28a with a large diameter and second gear wheel 28b (shown in FIG. 4) with a small diameter. First gear wheel 28a has a larger diameter than second gear wheel 28b. Gear wheel arrangement 22 is mounted on second axle 21 of focusing device 20. Second gear wheel 28b transfers its rotational movement to a gear rack 42 which moves microscope stage 6 in the direction of optical axis 5. Therefore, gear wheel arrangement 22 is mounted permanently on second axle 21. Second gear wheel 28b of gear wheel arrangement 22 is in engagement with gear rack 42. A pin 60 is provided at the periphery of first gear wheel 28a of gear wheel arrangement 22. A slot 61 formed in the gear wheel 28a on the second axle 21.

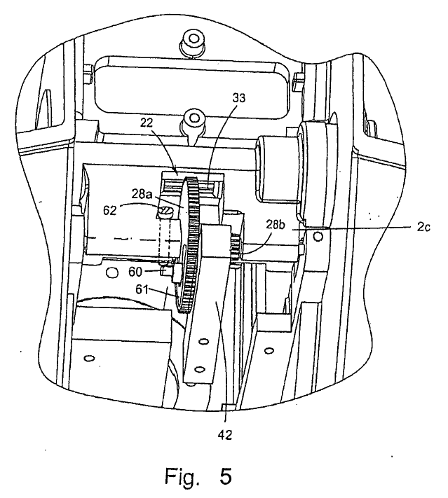

FIG. 4 shows the arrangement of the focusing device 20 in the interior 2c of the microscope stand 2. The focusing device 20 extends between the two opposing side walls 2a and 2b of the microscope stand 2. The second gear wheel 28b of gear wheel arrangement 22 is in engagement with gear rack 42. The pin 60, mounted slidably within said slot 61, is in contact with an adjustable stop 62 on the focusing device 20. The pin 60 is slidably mounted in said slot 61 formed in the gear wheel 28a on the second axle. The slot 61 has the form of an arc. The arc defines a first end 65 and a second end 66, both of which limit the sliding movement of the pin 60 while the pin 60 is in contact with the adjustable stop 62 provided on the focusing device 20. The adjustable stop 62 comprises an adjustable screw, which is mounted in a recess 33 of the focusing device 20. The adjustable stop 62 extents trough the focusing device 20, such that the pin 60, depending on its position, can be in operational relationship with a top end (see FIG. 4) or a bottom end (see FIG. 5) of the adjustable screw.

FIG. 5 shows the arrangement of the focusing device 20 in the interior 2c of the microscope stand 2. The focusing device 20 extends between the two opposing side walls 2a and 2b of the microscope stand 2. In the position, as shown in FIG. 4, the pin 60 can be in operational relationship with the bottom end of the adjustable screw. Once the pin 60 is in contact (bottom end or top end) with the adjustable screw the gear wheel 28a is can still rotate until the pin 60 reaches the first end 65 or the second end 66 of slot 61.

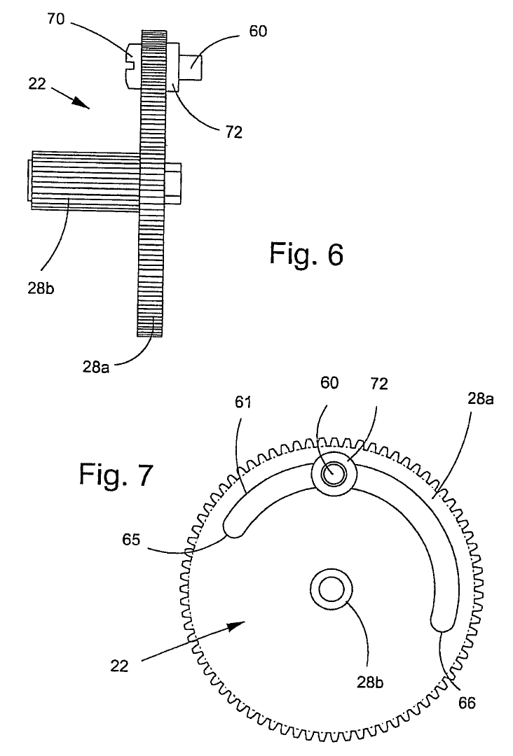

FIG. 6 shows a side view of gear wheel arrangement 22. Gear wheel arrangement 22 comprises first gear wheel 28a and second gear wheel 28b both of which are arranged coaxially. First gear wheel 28a has a larger diameter than second gear wheel 28b. Pin 60, which is positioned at the outer periphery of first gear wheel 28a. The pin 60 is mounted to first gear wheel 28a by nut 70 and a washer 72 so that the pin 60 can slide within slot 61.

FIG. 7 shows a plan view of gear wheel arrangement 22. Second gear wheel 28b is provided at the side of first gear wheel 28a which carries nut 70 for mounting pin 60. Second gear wheel 28b has approximately the length of the width of gear rack 42.

What is claimed is:

1. A microscope comprising
a microscope stand;
a focusing device disposed inside the microscope stand, the focusing device including a first axle and a second axle, a first gear wheel disposed on the first axle and a second gear wheel disposed on the second axle, the second gear wheel including a slot, the first and second gear wheels configured to cooperate so as to transfer rotating movement from the first axle to the second axle;
at least one operating element movably disposed at an end of the focusing device, the end of the focusing device projecting through a side wall of the microscope stand;
a pin slidably received in the slot of the second gear wheel; and
an adjustable stop disposed on the focusing device so as to be contactable by the pin.

2. The microscope as recited in claim 1 wherein the slot of the second gear wheel has a form of an arc and includes a first end and a second end, the first and second ends being configured to limit a sliding movement of the pin.

3. The microscope as recited in claim 1 wherein the adjustable stop includes an adjustable screw disposed in a recess of the focusing device and extending through the focusing device, a top end of the screw being in contact with the pin in a first position of the pin and a bottom end of the screw being in contact with the pin in a second position of the pin.

4. The microscope as recited in claim 3 wherein the pin is configured to slide in the slot when the adjustable screw is in contact with the pin and the pin is not in contact with the first end of the slot and not in contact with the second end of the slot.

5. The microscope as recited in claim 1 further comprising:
a microscope stage moveably disposed on the microscope stand; and
an objective defining, in a working position thereof, an optical axis;
wherein the at least one operating element is configured to effect a relative movement between the microscope stage and the objective.

6. The microscope as recited in claim 1 wherein the at least one operating element includes a first operating element disposed at a first end of the first axle and a second operating element is disposed at a second end of the first axle.

7. The microscope as recited in claim 1 wherein the operating element is movable in at least one of a horizontal and a vertical direction.

8. The microscope as recited in claim 1 wherein the sidewall includes an elongated slot configured to enable a change of position of the at least one operating element in a horizontal and a vertical direction.

9. The microscope as recited in claim 1 wherein the focusing device has a pivot axis, the focusing device together with the at least one operating element being pivotable about the pivot axis so as to adjust a position of the at least one operating element relative to the side wall of the microscope stand.

10. The microscope as recited in claim 1 wherein the focusing device includes a third gear wheel disposed on the second axle, the third gear wheel being disposed coaxially relative to the second gear wheel, the second gear wheel having a larger diameter than the third gear wheel.

11. The microscope as recited in claim 1 wherein the at least one operating element includes a first operating element movably disposed at a first end of the focusing device and a second operating elements movably disposed at a second end of the focusing device, the first end of the focusing device projecting through a first side wall of the microscope stand, the second end of the focusing device projecting through a second side wall of the microscope stand.

12. A focusing device for a microscope, the focusing device comprising:
a first axle having a first gear disposed thereon;
a second axle having a second gear wheel disposed thereon, the second gear wheel including a slot, the second gear wheel configured to cooperate with the first gear wheel so as to transfer rotating movement from the first axle to the second axle;
at least one movably disposed operating element attached to the first axle and configured to effect movement of a microscope stage along an optical axis of the microscope;
a pin slidably received in the slot of the second gear wheel; and
an adjustable stop disposed on the focusing device so as to be contactable by the pin.

13. The focusing device as recited in claim 12 wherein the slot of the second gear wheel has a form of an arc and includes a first end and a second end, the first and second ends being configured to limit a sliding movement of the pin.

14. The focusing device as recited in claim 12 wherein the adjustable stop includes an adjustable screw disposed in a recess of the focusing device and extending through the focusing device, a top end of the screw being in contact with the pin in a first position of the pin and a bottom end of the screw being in contact with the pin in a second position of the pin.

15. The focusing device as recited in claim 12 wherein the pin is configured to slide in the slot when the adjustable screw is in contact with the pin and the pin is not in contact with the first end and not in contact with the second end of the slot.

16. The focusing device as recited in claim 12 wherein the at least one operating element is movable in at least one of a horizontal and vertical direction.

17. The focusing device as recited in claim 12 further comprising a third gear wheel disposed on the second axle, the third gear wheel being disposed coaxially relative to the second gear wheel, the second gear wheel having a larger diameter than the third gear wheel.

18. The focusing device as recited in claim 12 wherein the pin is slidably disposed at a periphery of the second gear wheel.

19. The focusing device as recited in claim 12 wherein first axle projects through a first elongated slot in a sidewall of the microscope, the first axle being movable in at least one of a horizontal and a vertical direction.
